(19) United States
(12) Patent Application Publication
(10) Pub. No.: US 2012/0284097 A1
(43) Pub. Date: Nov. 8, 2012

(54) SYSTEM AND METHOD FOR PROMOTION AND MARKETING THROUGH A NETWORKED MULTI-LEVEL REFERRAL FEE PROGRAM

(75) Inventor: Francisco Javier Codina, Miramar, FL (US)

(73) Assignee: NEURS LLC, Palo Alto, CA (US)

(21) Appl. No.: 13/099,396

(22) Filed: May 3, 2011

(51) Int. Cl. G06Q 30/02

(52) U.S. Cl. 705/14.16

(57) ABSTRACT

This invention relates to payments of referral compensation. Specifically, this invention relates to payment of compensation, in the form of referral fees in multi-levels, for the marketing and promotion of goods and services that can be purchased and/or tracked via the Internet or other interactive networks via one or more computing devices.

### FIELD OF INVENTION

This invention relates to payments of referral compensation. Specifically, this invention relates to payment of compensation, in the form of referral fees in multi-levels, for the marketing and promotion of goods and services that can be purchased and/or tracked via the Internet or other interactive networks via one or more computing devices.

### BACKGROUND OF THE INVENTION

One of the biggest problems affecting millions of businesses worldwide is determining how to reach the greatest amount of customers in the most effective and cost efficient way possible. The popularity of the Internet and the World Wide Web has made it possible for just about any business to create products and services and adequately offer them directly to consumers worldwide. Businesses that in the past would have to visit customer one by one or wait for customers to physically enter their premises, can now transact business with persons all over the world though the World Wide Web.

Many brilliant websites have been created to solve simple problems and provide a service that adds value, saves money, or helps members be more productive. There are numerous smart, extremely creative and fully functioning websites that garner only a small amount of traffic and use. Having a clever offering, or an amazing service that a large number of people worldwide would find valuable is no guarantee of financial success.

Many entrepreneurs lack the marketing skills to successfully expand their business or lack the financial resources, because of low or insignificant numbers of users, to hire the right marketing personnel, or to invest in an advertizing budget. Additionally, many early stage businesses that embark on utilizing these traditional marketing techniques have to either get massive loans that drain their monthly cash flow or give away part of their businesses to venture capitalist for the funds needed to market the business. Entrepreneurs do all this, without having any form of guarantee that they will grow their membership or customer base as a result. Making matters worse, in today's economic environment, getting access to loans and/or venture capital has become increasingly more difficult.

The biggest problem is that to reach a large audience and successfully convince the target market to buy a product or join the use of a paid service requires expensive traditional marketing techniques (i.e.; television commercials, infomercials, sales people on salary or commissions, ads in newspapers and magazines, etc.). To solve some of these challenges, many great online businesses, have resorted to a controversial marketing technique called “FREEMIUM”; whereby a business gives away a basic form of a service at no cost, and then charge for premium or upgraded services of the same offer. This has proven effective for some sites, but most business have found little or no effect over other marketing strategies. In the end FREE has no value so it becomes increasingly difficult to turn free members to paying members.

Another problem encountered by online merchants is an inability to effectively market goods via their website because the customer cannot interact with a representative or current user of the services or products offered by the website, that can help them understand the benefits of the site, product, or service, due to a lack of human resources. This is due in large part to the fact the these business don't have the revenue or profits to commit to adequately market their products and services.

One solution, already proliferated in the internet that attempts to solve this problem is the use of referral fees or compensation, sometimes in the form of credits, to motivate existing customers or users of a service or product marketed or at least tracked online, to refer others members or customers. This approach has had limited success. In some cases, very little success. The biggest challenge facing the current system and methods for incentivizing the referral is the low amounts offered, which many times is less than $40 and the fact that if you refer a person that becomes a customer or member of service that then refers others, you do not receive any further compensation for those newly referred members, even though the revenue generated by their purchase or membership was indirectly created by your efforts to refer a member that in turn, referred them. Many “business minded” individuals, specifically entrepreneurs, have a hard time referring others for such little benefit because, they, more than anyone else, understand the value of a referral, not just for the initial revenue they bring to a business but for the recurring value they will generate over time as customers, and for the value they will add to the business in the future by referring others customers or members.

Needless to say, programs that use referral fees to motivate word-of-mouth marketing of a business, product, or services already exists and are being used by many business all over the world. These programs may be referred to as uni-level or singular referral fee programs; since they either pay you once, for a qualified referral, or pay you a continuous compensation amount if the referred person continues using their service. Regardless, in either case, the referral compensation is only paid for one level of the referral.

Therefore, there is a need in the art for a system and method for improving the referral fees process by providing a networked solution that automates and performs referral fee processing in a multi-level format. These and other features and advantages of the present invention will be explained and will become obvious to one skilled in the art through the summary of the invention that follows.

### SUMMARY OF THE INVENTION

This invention relates to payments of referral compensation. Specifically, this invention relates to payment of compensation, in the form of referral fees in multi-levels, for the marketing and promotion of goods and services that can be purchased and/or tracked via the Internet or other interactive networks via one or more computing devices.

According to an embodiment of the present invention, the system and method herein described solve the problem of not being able to reach a large amount of consumers in an effective and cost efficient manner. The system and methods herein described solve these problems for any form of online business, or merchants, in a plurality of industries, that markets products and services that are exclusively sold online or that are sold through retail, direct sales, or any form of marketing, but that it's purchases could be tracked online.

According to an embodiment of the present invention, the system and methods herein described may be implemented with products or services that are paid for in a recurring manner; meaning that customer will consistently and in a predictable frequency continue to either purchase more product or pay for the continuous services rendered. Even though the preferred embodiment is in the form of referral fees paid for members referring members of a business service, this invention could be easily adapted to be used with a plurality of services that have a recurring payment, like communications services, including cable, satellite television, phone and internet service, as well as utilities, including electric and water services, and food, beverage, and perishable product purchases, loans and financing services, investments, insurance and banking products, and any business or personal service whereby a customer, user or member of a business would generate, not just a onetime transaction, but multiple transaction over a period of time that lends itself to be used in the described invention.

According to an embodiment of the present invention, benefits to referring members are multiple. a referring member can feel good about referring others with the knowledge that if those they refer go on to refer one or more customers or members, they will be adequately compensated for indirectly helping create more revenue and perhaps profits to the business. In addition, referring members of the program may not have any out of pocket costs for the services or products bought or used through the business they are referring and in some cases the compensation received for referral these members and the multi-level fees received from their referral of others on a consistent basis could generate enough income to help them pay other bills, loans, and perhaps even save money for the future.

According to an embodiment of the present invention, benefits to a business that uses the systems and methods herein described are multiple. a business would, in many cases, generate an increased level of interest in the referral program by their current members, users, or customers. The level of interest will generate more word-of-mouth advertizing. In many cases, and if used effectively, the systems and methods herein described will allow the business to lower or significantly reduce, if not altogether eliminate the need to market the products through traditional and costly means. Part of this cost reduction, could be used to further incentivize the members to refer additional customers. In many cases, the involvement of a member in multi-level referral fee program could help to increases the loyalty of that member, customer or user, to the business, since the cost of their own purchases or membership fees, could be significantly reduced, or completely waived through the use of credits to their own account with the business. Yet another benefit is that it allows a business to price their product correctly from the beginning, avoiding the need to creating thousands or even millions of users that get used to paying nothing for services that otherwise should have a cost or fee.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS:

FIG. 1 is a schematic overview of the network system for carrying out this invention;

FIG. 2 is a flowchart of the process describing the procedure for presenting the referral fee program to the user or member of a site, and attaining their consent to participate;

FIG. 3 is a screen shot of an example of how referral fees can be paid utilizing a set dollar amount and set number of levels;

FIG. 4 is a screen shot of the example explained in FIG. 3 and how the calculations would be made if each user or member referred another user/member;

FIG. 5 is a screen shot of the example explained in FIG. 3 and how the calculations would be made if each user or member referred at least two new user/member to the site;

FIG. 6 is a screen shot of the referral fee projection tool, available online at the site of the company running the referral fee program whereby a member can create a hypothetical projections of their referral fees using a set number of variables that they can enter;

FIG. 7 is a screen shot of the month by month calculations with graphics derived once a member completes the information on FIG. 6;

FIG. 8 is a screen shot of the agreements that a member must approve of before becoming part of the referral fee program;

FIG. 9 is a flowchart depicting the steps that a member would take to sign-up another member while being logged-in to the computer network where the invention is started and tracked;

FIG. 10 is a flowchart depicting the steps that a member would take to sign-up another member by sending a link that will take the potential member to the computer network where the invention is started and tracked, with the pre-populated information to track the referral;

FIG. 11 illustrates the procedure of how referral fees are tracked on the application server by assigning each level of referral fee compensation a unique ID with the application server that is linked to the email being used by the person making the referral and the person getting referred;

FIG. 12 is a flowchart depicting the steps that a member would take to track how many referral fees have been earned and at which levels through computer network where the invention is started and tracked; and

FIG. 13 is a flowchart depicting the procedure by which the member would receive their referral fees through computer network where the invention is started and tracked.

### DETAIL DESCRIPTION

This invention relates to payments of referral compensation. Specifically, this invention relates to payment of compensation, in the form of referral fees in multi-levels, for the marketing and promotion of goods and services that can be purchased and/or tracked via the Internet or other interactive networks via one or more computing devices.

According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

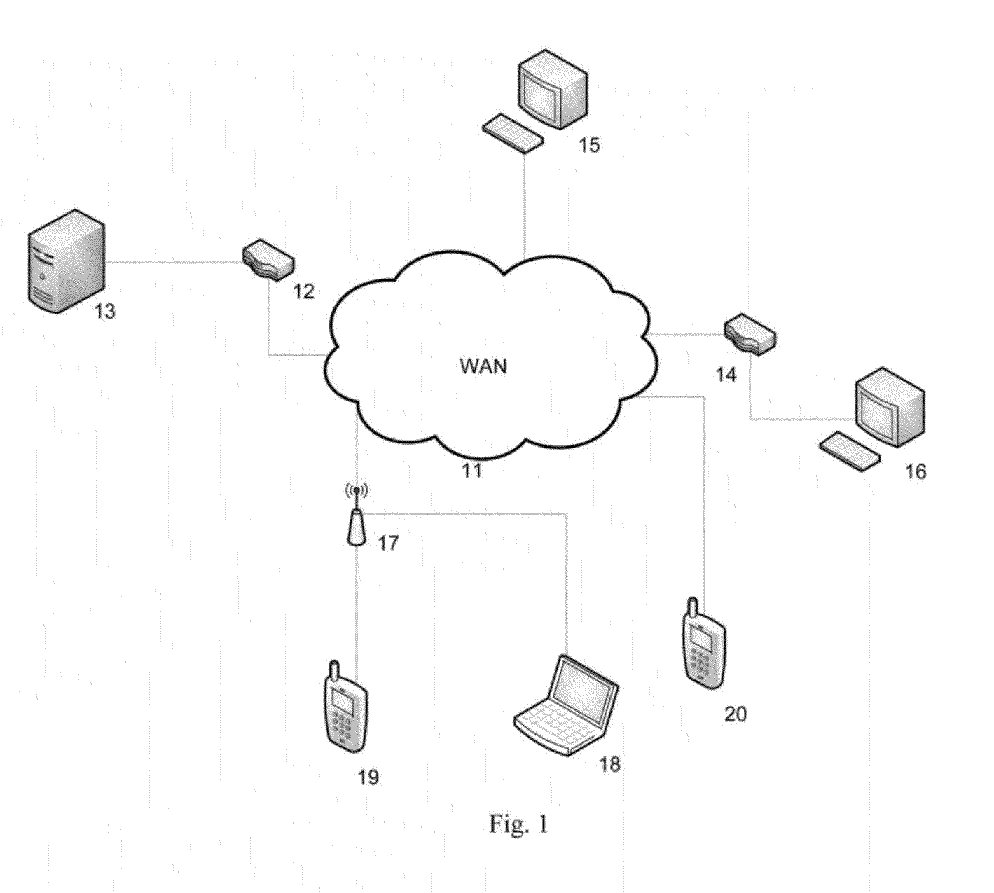

Referring to FIG. 1, a schematic overview of a system in accordance with an embodiment of the present invention is shown. The system is comprised of one or more application servers 13 for electronically storing information used by the system. Applications in the server 13 may retrieve and manipulate information in storage devices and exchange information through a WAN 11 (e.g., the Internet).

According to an exemplary embodiment, as shown in FIG. 1, exchange of information through the WAN 11 or other network may occur through one or more high speed connections directed through one or more routers 12. Router(s) 12 are completely optional and other embodiments in accordance with the present invention may or may not utilize one or more routers 12. One of ordinary skill in the art would appreciate that there are numerous ways server 13 may connect to WAN 11 for the exchange of information, and embodiments of the present invention are contemplated for use with any method for connecting to networks for the purpose of exchanging information.

Members may connect to server 13 via WAN 11 or other network in numerous ways. For instance, a Member may connect to the system i) through a computing device 15 directly connected to the WAN 11, ii) through a computing device 16 connected to the WAN 11 through a routing device 14, iii) through a computing device 18 or 19connected to a wireless access point 17 or iv) through a computing device 20 via a wireless connection (e.g., CDMA, GMS, 3G, 4G) to the WAN 11. One of ordinary skill in the art would appreciate that there are numerous ways that a member may connect to Server 13 via WAN 11 or other network, and embodiments of the present invention are contemplated for use with any method for connecting to Server 13 via WAN 11 or other network.

According to an embodiment of the present invention, an individual or organization may signup to become a member of the system herein provided. In an exemplary embodiment, an individual or organization would go through a registration process, whereby they would provide identifying information to be stored in application server 13. This identifying information may be used, for instance, to identify the user, secure their login or process financial transactions. One of ordinary skill in the art would appreciate there are numerous ways to provide and manage registration processes, and embodiments of the present invention are contemplated for use with any method for providing and managing registration processes.

Exemplary Methods

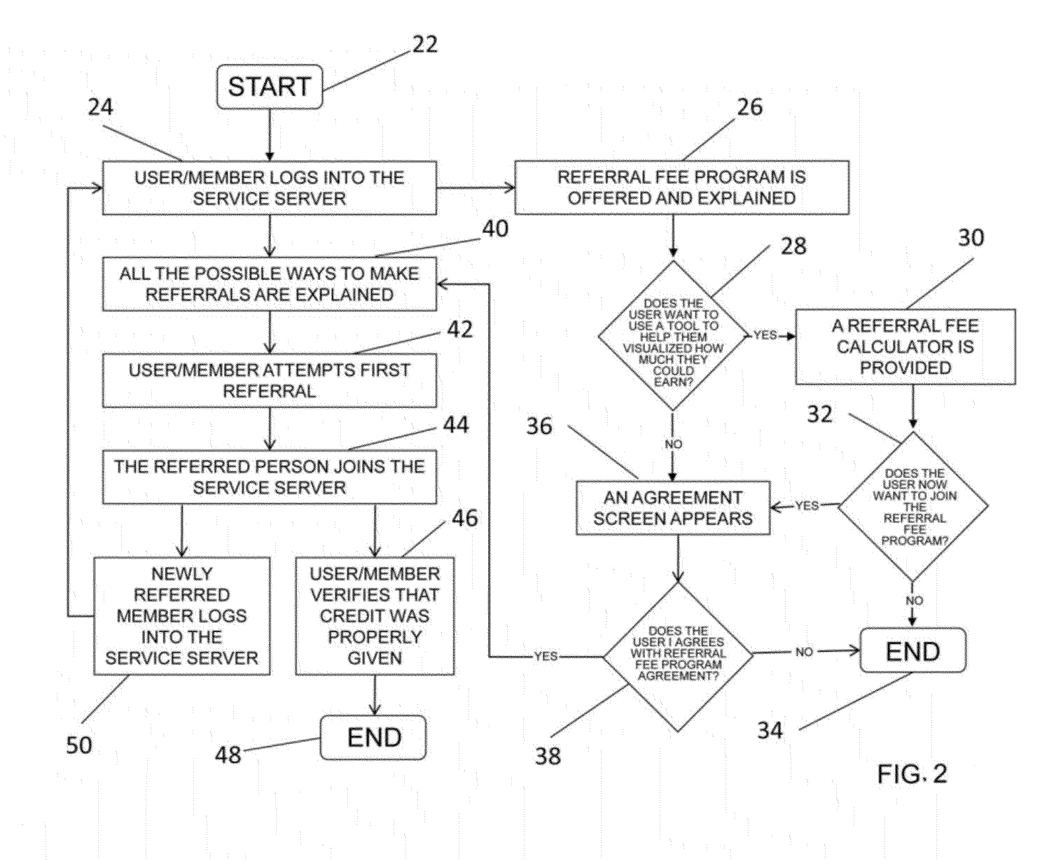

Turning now to FIG. 2, an “enrollment” step, in accordance with an embodiment of the present invention is described. This process could be provided to one or more users or members using the application server 13 to refer other members at any given time. The method starts at block 22 by the user or member when they begin the process of logging-in 24 by utilizing their computing device 15 to login to the application server 13 through a WAN 11.

According to an embodiment of the present invention, at process block 26 the user or member is logged in and an offer to enroll in the referral program is explained. The login process may be conducted in one or more secured or unsecured manners. One of ordinary skill in the art would appreciate that there are numerous ways of providing secured and unsecured login processes, and embodiments of the present invention are contemplated for use with any method of secured and unsecured login processes.

According to an embodiment of the present invention, at process block 28 the user/member is presented with a question at the bottom of the screen regarding the possibility of using an optional tool that can help him/her visualize how much he/she stand to gain if he/she enrolls in the program and refer other potential members 20. In an exemplary embodiment, the user or member could decide to answer “YES” or decide not to do so by clicking on “NO”. In other embodiments, the user or member could be presented with any number of similar decision selections (e.g., “Accept”, “Reject”).

According to an embodiment of the present invention, at process block 36, assuming the user or member chose “NO” at process block 28, the Referral Fee agreement screen appears. The Referral Fee agreement may be comprised of, for instance, one or more display components containing a referral fee agreement, additional agreements or any combination thereof. The user or member could decide to AGREE with the terms set forth in the referral fee agreement and additional agreements in order to participate or chose not to participate, by re-directing to another section of the site.

At process block 34 the process ends if an user/member chose not to participate.

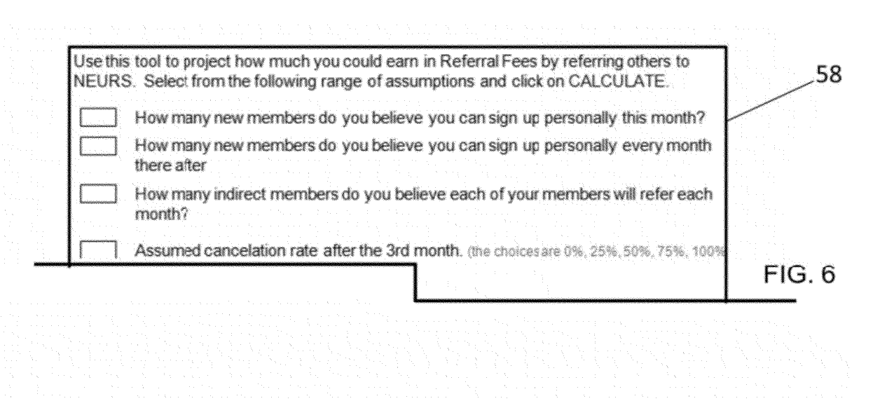

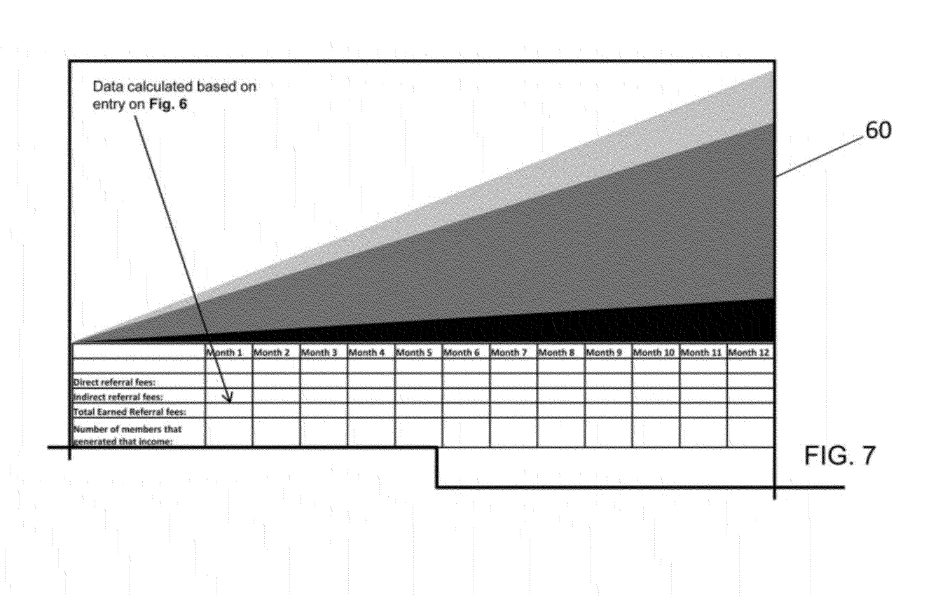

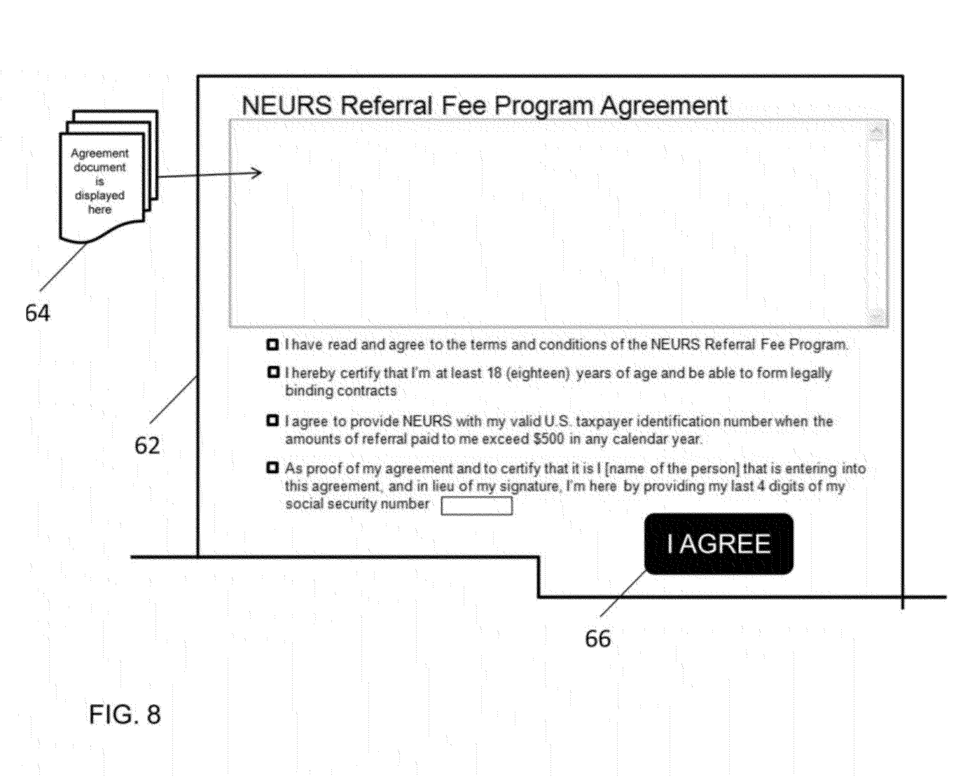

Alternately, the user/member could choose “YES” at process block 28 whereby he/she would be re-directed to a referral fee program calculator 30. FIG. 6 and FIG. 7 explain how a referral fee calculator works in detail, in accordance with an exemplary embodiment of the present invention. At the end of referral fee calculator page, after having completed a first calculation, the user member is asked if he/she wishes to join the referral fee program. If he/she chooses “NO” the process would end at process block 34. If he/she chooses “YES” an agreement screen appears (FIG. 8 illustrates an exemplary embodiment of how the agreement screen appears to the user) and assuming he/she chooses to AGREE at process block 38 the user/member is then taken to a tutorial screen 40 where all possible ways to make referrals are explained to the user/member.

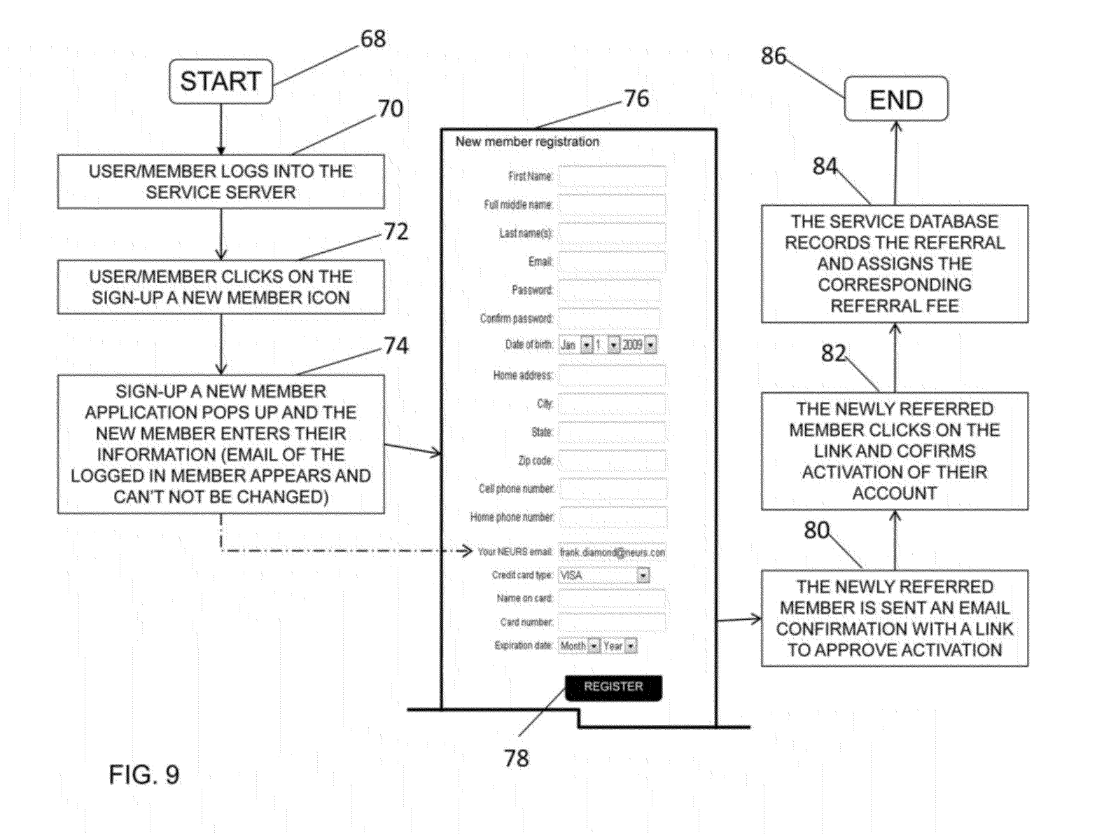

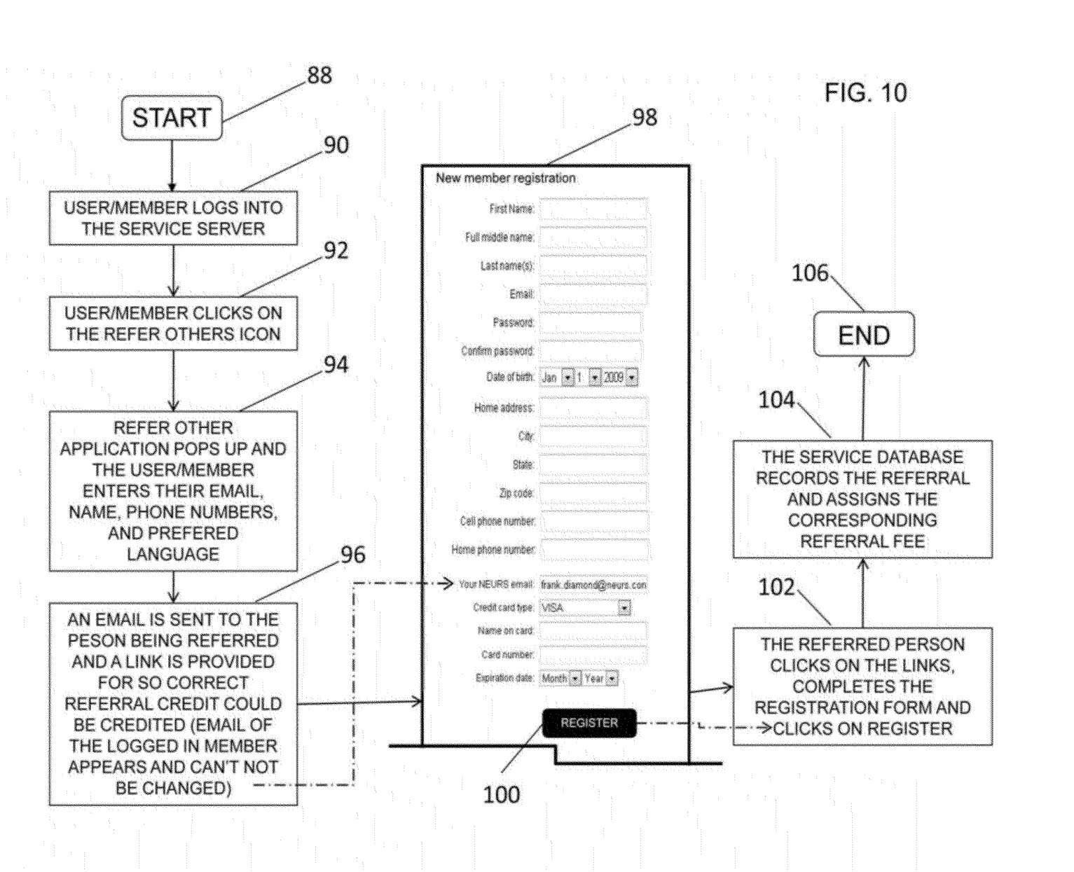

According to an embodiment of the present invention, at process block 42 the user member attempts to make a referral using one of the various methods of doing so as explained below in detail (i.e., detailed description of FIGS. 9-10).

According to an embodiment of the present invention, at process block 44 a referred person 20 registers to be part of a business entity being referred through the application server 13.

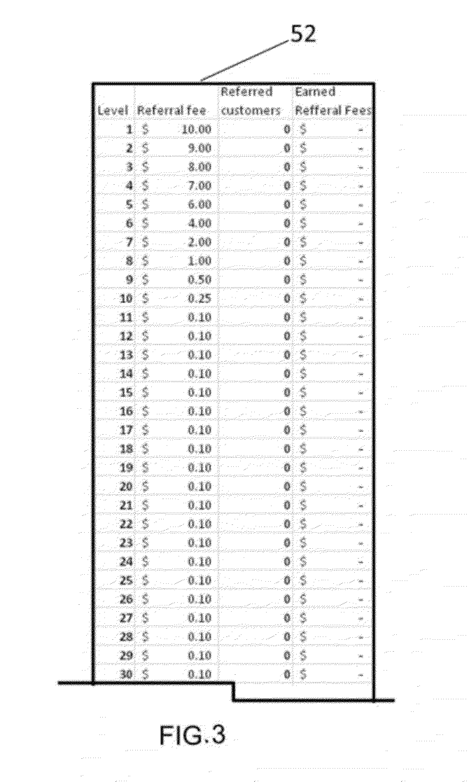

According to an embodiment of the present invention, at process block 46 the user member that referred the new member verifies that credit was properly given for his/her referral. FIG. 12 and FIGS. 3-5 show exemplary embodiments of this process and additional detail is discussed below.

According to an embodiment of the present invention, at process block 48 the method ends. The method may be repeated, including or excluding the steps required to register the user, at any time the user or member decides to refer another person.

Alternately, the person referred at process block 44 that accepted the referral and became a member/user/consumer of the business entity that they were referred to, logs into the application server 13 at process block 50 and starting again the method shown in FIG. 2.

Turning now to FIG. 3, an exemplary embodiment of a multi-level referral fee program table, in accordance with an embodiment of the present invention. The multi-level referral fee program table shown in FIG. 3 depicts thirty individual levels and a total of $49.75 allocated for the monthly referral fee program assuming one referred customer at each of the thirty individual levels. Although the present invention, for purposes of illustrating the process uses these parameters of thirty levels and $49.75 this invention could be implemented using a plurality of possible combinations between levels and dollar amounts, depending mainly, on the product being sold through the referral program, it's profit margins, and the size of the marketplace being targeted. While thirty levels and a $49.75 payout may be excessive for a product with a limited market and small profit margins, the complete inverse could be said of a product with a large, perhaps international profit base and with healthy profit margins that could lend itself to make more financially attractive the total payout amount. The figures discusses are not meant to be static but just illustrative of the functionally of such a system as described by the present invention.

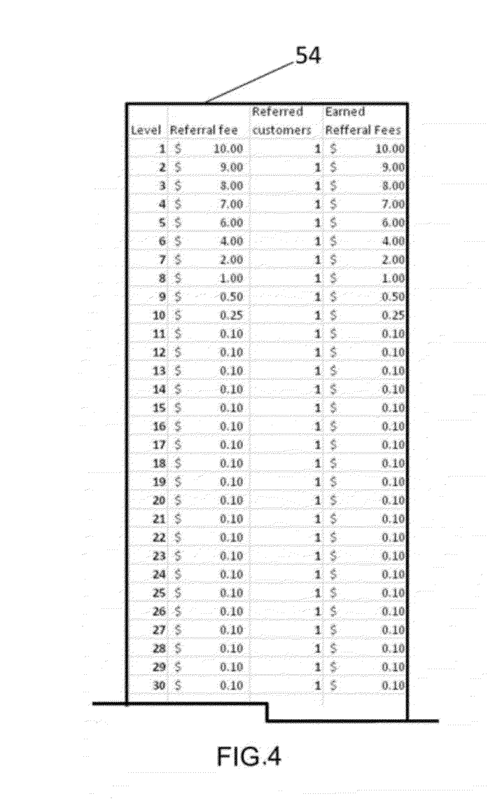

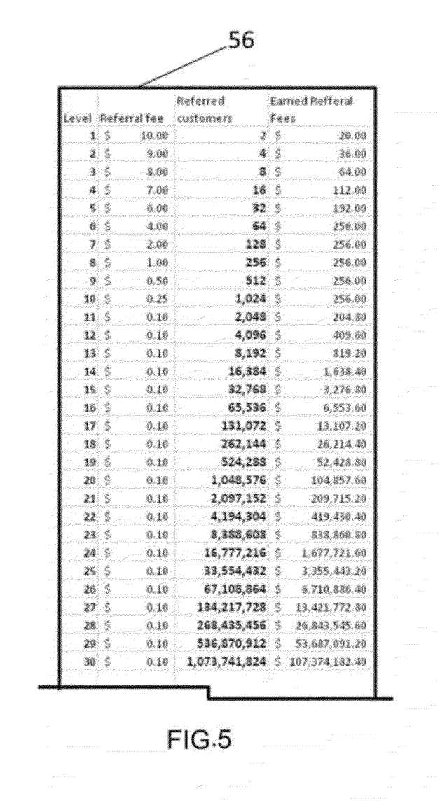

Turning now to FIG. 4, an exemplary embodiment of levels as explained in FIG. 3 is shown. In this exemplary embodiment, an example of how much could be earned by a user/member that refers 1 person that goes on to refer 1 person and so on for the thirty levels of referral fees is described.

Turning now to FIG. 5, an exemplary embodiment of levels as explained in FIG. 3 is shown. In this embodiment, the same example of levels as explained in FIG. 3 with an example of how much could be earned by a user/member that refers 2 new members, that in turn refer 2 new members each, and so on for the thirty levels of referral fees being explained. In this hypothetical example a market of 1 Billion people could be reached by this present invention, by rewarding the initial member with enough compensation to merit his efforts in advocating the product and/or service being offered by the business entity promoting the referral fee program.

FIG. 6 is a screen shot of a section of a website where the questions 58 are asked to create the hypothetical projection of how much a member or user could earn by referring others to the business entity offering the referral fee program, in accordance with an embodiment of the present invention.

FIG. 7 illustrates information that may be presented to the user/member once the questions are answered in FIG. 6, in accordance with an embodiment of the present invention. A graphical illustration 60 is generated by the system depicting potential direct referral fees earned, potential indirect referral fees and a potential total amount of referral fees as well as the number of referred members that will generate those referral fees. The embodiments shown in FIGS. 6-7 are for the purpose of illustrating the processes of the present invention according to an exemplary embodiment. One of ordinary skill in the art would appreciate that this invention may be implemented using a plurality of possible combinations between questions, time periods, and displays of the information. The information explained is not meant to be static but just illustrative of the functionally of such a system as described by an exemplary embodiment of the present invention.

FIG. 8 illustrates how the Referral fee program agreement works. The user/member has to first click all the boxes 62 indicating that he/she has read the Referral Fee Program Agreement 64 and agree to its terms, then certify that he/she is of age to enter into such a contract, agree to provide the business entity with the tax payer identification, where applicable, and in lieu of a signature provide us with his/her social security number as a condition to enter into this agreement. Once they click on the I AGREE 66 button he/she is enrolled in the program.

FIG. 9 shows an exemplary embodiment of a “sign-up a new member” method of the present invention as described herein. This process could be provided to one or more users or members using the application server 13 to refer other members at any given time. The method starts at block 68 by the user or member when they begin the process of logging-in 70 to the application server 13 through the WAN 11.

According to an embodiment of the present invention, at process block 72 the logged-in user/member clicks on a sign-up a new member icon.

According to an embodiment of the present invention, at process block 74 a sign-up a new member application pops up on a display of the member's computing device 112. The sign-up a new member application may be comprised of modules contained on the application server 13, the member's computing device 15 or any combination thereof.

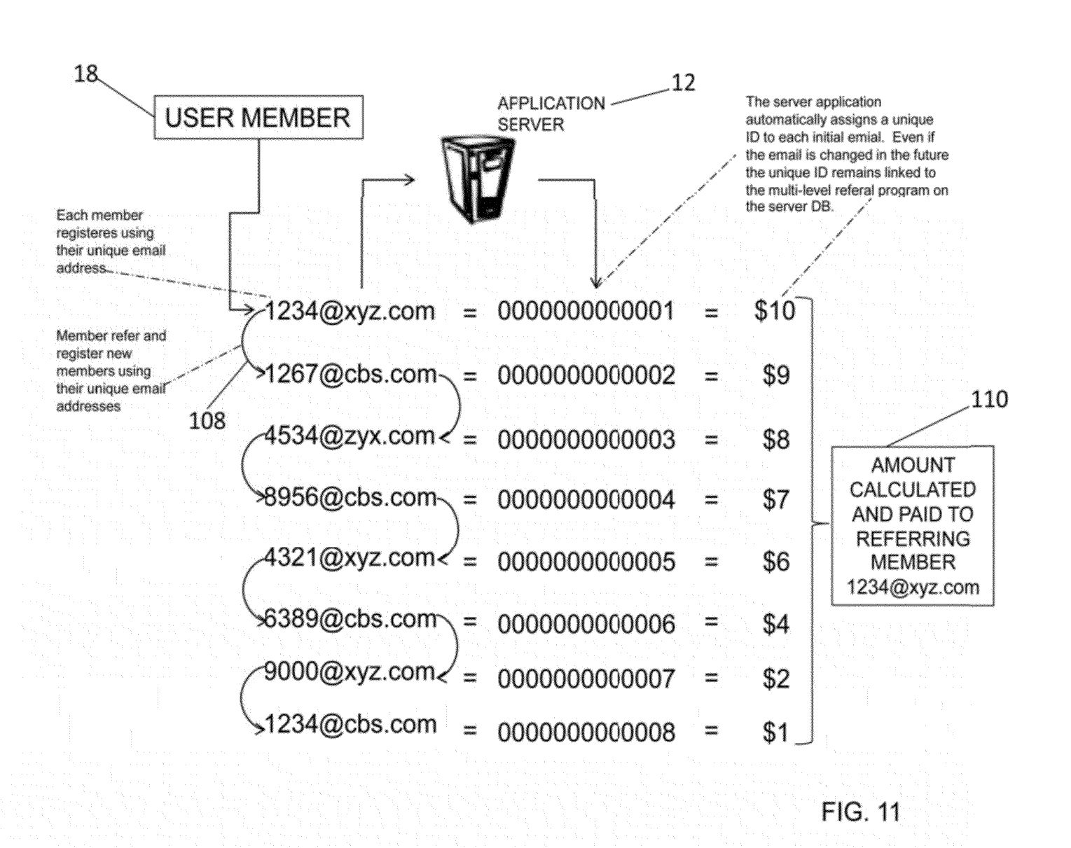

According to an embodiment of the present invention, at process block 76 the user/member can enroll another member by inputting information requested by the sign-up a new member application to create a new member account. According to an embodiment of the present invention, information related to the logged-in member may automatically populate information sections. For instance, the email address section of the person making the referral. This allows the application server 13 to track who to assign a referral fee to as explained in FIG. 11.

According to an embodiment of the present invention, at process block 78 the user/member clicks on REGISTER 78 and an account related to the new member is created and stored in the application server 13.

According to an embodiment of the present invention, at process block 80 the referred member is sent an email with a link to confirm and approve their activation. If the referred member chooses not to activate their account, the credit card is refunded, and the referral credit is not given to the referring user/member.

According to an embodiment of the present invention, at process block 82 the newly referred member may click on the links and confirms activation of his/her account, thus becoming a user/member of the site, eligible to enroll in the referral fee program and refer other members to the site.

According to an embodiment of the present invention, at process block 84 the application server records the referral and assigns the corresponding referral fee.

At process block 86 the process ends. The steps are not required to be executed in this order, and one of ordinary skill in the art would appreciate that these steps could be executed in a variety of different manners as well as having two or more of the steps executing simultaneously.

FIG. 10 shows an exemplary embodiment of a “refer others” step in accordance with embodiments of the present invention. This process could be provided to one or more users or members using the application server 13 to refer other members at any given time. The method starts at block 88 by a user or member when they begin the process of logging-in 90 to the application server 13 through the WAN 11.

According to an embodiment of the present invention, at process block 92 the logged-in user/member clicks on the sign-up a new member icon. At process block 94 a refer others application pops up. The refer others application may be comprised of modules contained on the application server 13, the member's computing device 15 or any combination thereof. The user/member enters the email address, name, phone number, and language preference of the person being referred.

At process block 96 an email is sent from the application server 12 to the referred person explaining one or more offers related to one or more products or services and a link is provided to the new member registration page. If the referred person clicks on that link, upon arrival on a new member registration page the email address of the person that referred them may automatically be populated.

At process block 98 the referred person arrives at a new member registration page where he/she will need to enter all the information needed to become a registered member of the site by clicking on REGISTER 100.

At process block 102 an account for the referred person is created and stored in the application server 12, and the referred person becomes a user/member of the site, eligible to enroll in the referral fee program and refer other members to the site.

At process block 104 the application server records the referral and assigns the corresponding referral fee. At process block 106 the process ends. The steps are not required to be executed in this order, and one of ordinary skill in the art would appreciate that these steps could be executed in a variety of different manners as well as having two or more of the steps executing simultaneously.

FIG. 11 is where an exemplary embodiment of an “assignment of the referral level” step of the present invention is described. This process could be provided to one or more users or members using the application server 12 to refer other members at any given time.

When a user/member register on the application server 12 using their email address as explained in FIGS. 9-10, the application server 12 automatically, and as programmed, assigns a unique ID to each member. That unique ID is also assigned a dollar value, as per the levels of a multi-level referral fee structure explained in FIGS. 3-5. From that point forward, that dollar value lined to the unique ID remains stored in the databases of the application server. In the event that a user/member decides to change his/her email address, the unique ID and dollar value will not change, allowing the proper tracking and payment of the multi-level referral fees. Upon the successful referral of a new member by a user/member, a new unique ID is created and a dollar value is saved and store in the databases of the application server 12. In this example, the user/member with email address 1234@xyz.com with unique ID 0000000000001 successfully refer an new member, 1267@cbs.com and immediately is assigned a unique ID 0000000000002 and consequently a dollar value; in this example, $9. This process is repeated each time 1234@xyz.com refers another member and when 1267@cbs.com refers others and so on. The example of the dollar assignment hereby explained through this illustration is for the purposes of calculating the referral commissions of the member that referred 1234@xyz.com and the subsequent referral fees earned by that member for all the other levels of indirect referrals that 1234@xyz.com generated. This process is of course repeated for each user/member of the site and the dollar amounts are assigned in relationship to the level of the referral and the user/member that referred that person and the user/member that referred that person and so on. The end result of this method of tracking is that an amount could be calculated 110 in order to compensate according to the referral fee program the referring member of 1234@xyz.com.

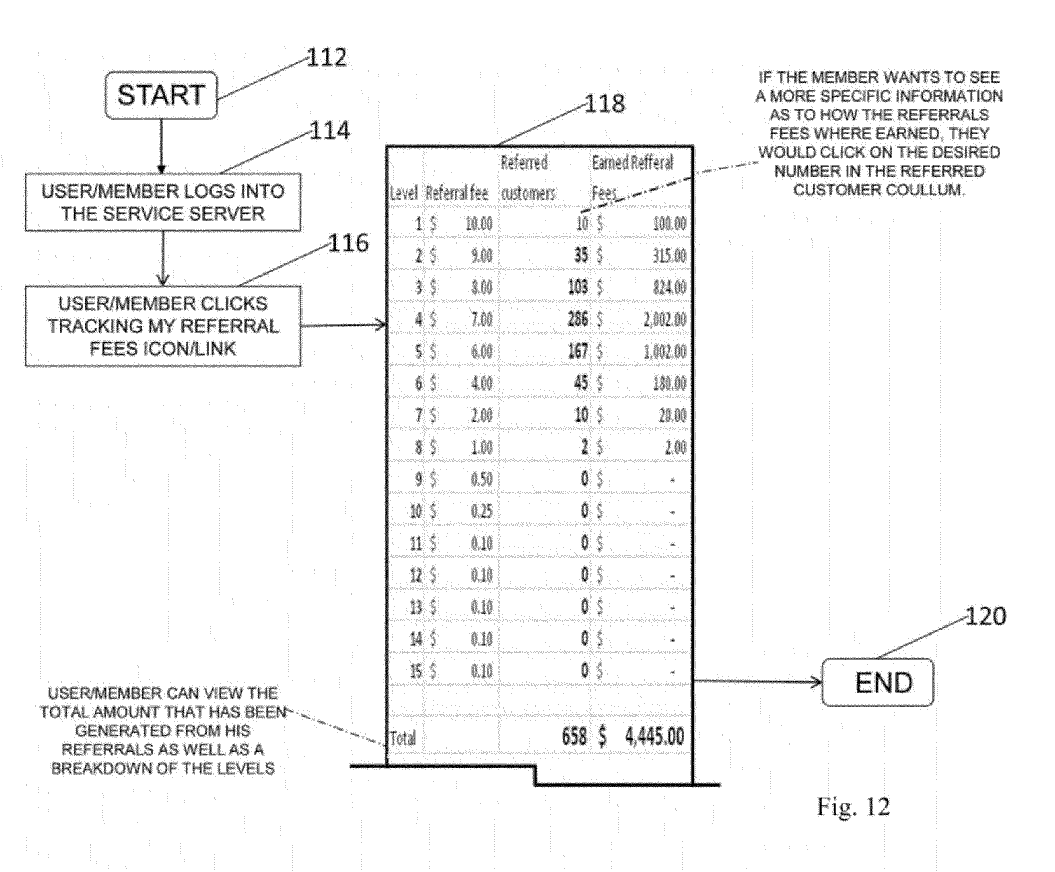

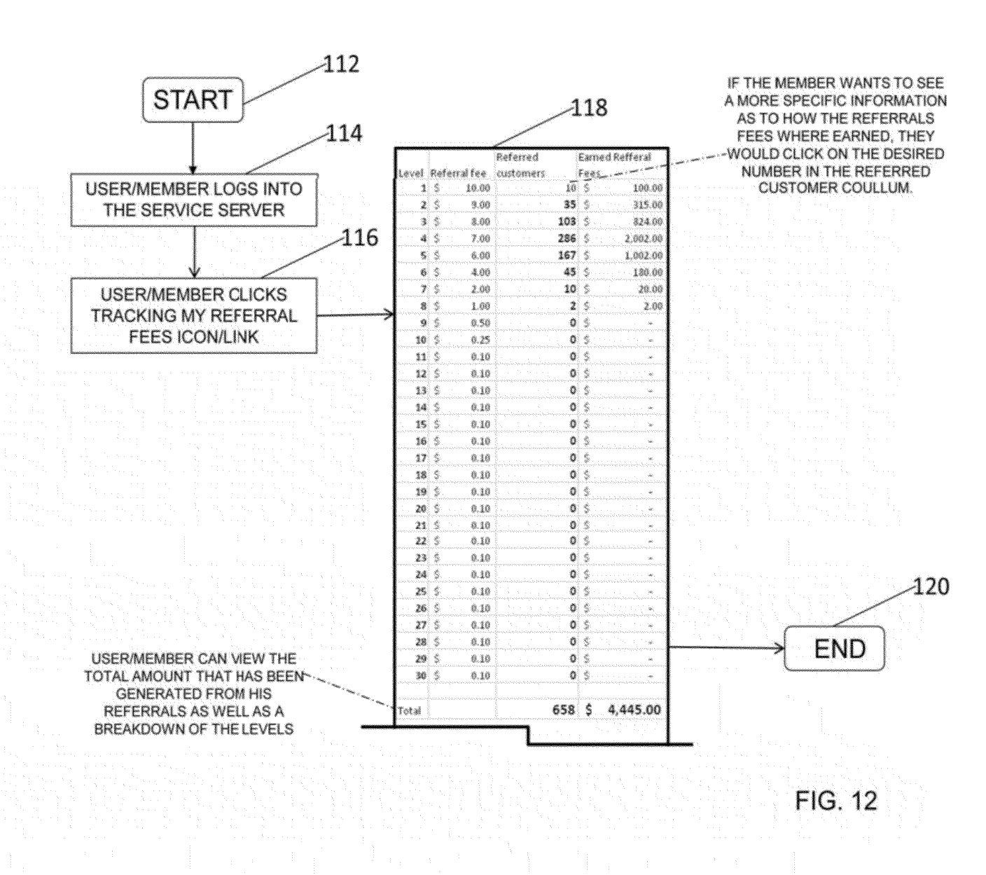

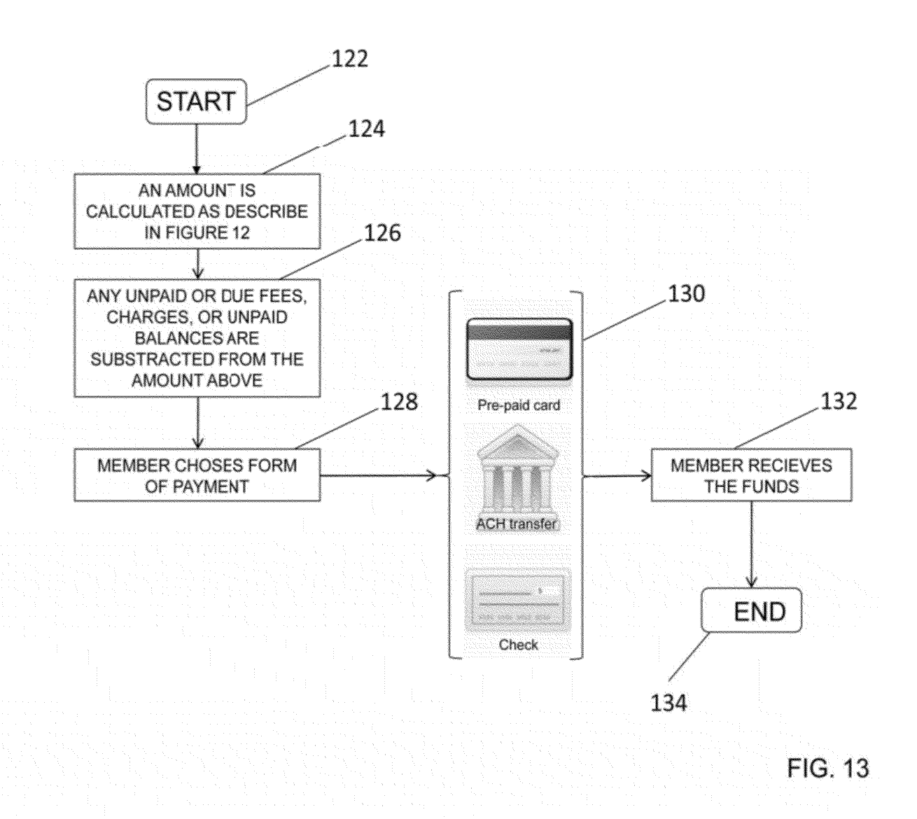

FIG. 12 shows an exemplary embodiment of a “Tracking the referral fees” step of the present invention. This method could be provided to one or more users or members using the application server 12 to refer other members at any given time.

The method starts at block 112 by the user or member when they begin the process of logging-in 114 to the application server 12 through the WAN 11. At process block 116 the logged-in user/member clicks on the Tracking My Referral Fees icon/link.

At process block 118 the referral fees are calculated and displayed in real time. The user/member could see the total amount of referral earned as well as being able to click on any of the numbers in the column of “Referred customers” and see who they have referred with more detail information. At process block 120 the process ends. The steps are not required to be executed in this order, and one of ordinary skill in the art would appreciate that these steps could be executed in a variety of different manners as well as having two or more of the steps executing simultaneously.

FIG. 13 shows an exemplary embodiment of a “Paying of the Referral Fees” step of the present invention. This process could be provided to one or more users or members using the application server 12 to refer other members at any given time. The method starts at block 122 by the user or member when they begin the process of logging-in 114 to the application server 12 through the WAN 11.

At process block 124 An amount calculated in FIG. 12 is obtained to be used in the calculation of an actual payout.

At process block 126 any unpaid or dues fees dealing with the product or service that generated the referral is deducted. Other charges, chargebacks, unpaid balances or fees, are deducted from this amount and presented to the user/member on a page of the application server 12 and viewable by only the user/member and the administrative staff

According to an embodiment of the present invention, at process 128 the user/member chooses the form of payment the prefer in order to obtain said referral fees. At process block 130 the choices shown are pre-paid card, ACH transfer to their bank account, and check to be mailed to them at a later time. Although for this example, these three methods of payments are shown, many more payment option, if available, could be provided to the user member, including any form of payment using a mobile communication device.

At process block 132 the user/member receives the funds. At process block 134 the process ends. The steps are not required to be executed in this order, and one of ordinary skill in the art would appreciate that these steps could be executed in a variety of different manners as well as having two or more of the steps executing simultaneously.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for automating a multi-level referral fee program, said method comprising:
receiving, at an application server, a first referral transmission request from a first user,
wherein said referral transmission request is comprised of data relating to a second user;
generating, at said application server, a first referral transmission from said first referral transmission request,
sending, from said application server, said first referral transmission to said second user;
receiving, at said application server, a first referral acceptance from said second user;
generating, at said application server, a first referral association between said second user and said first user;
receiving, at an application server, a second referral transmission request from said second user,
wherein said second referral transmission request is comprised of data relating to a third user;
generating, at said application server, a second referral transmission from said second referral transmission request,
sending, from said application server, said second referral transmission to said third user;
receiving, at said application server, a second referral acceptance from said third user;
generating, at said application server, a second referral association between said third user and said second user;
generating, at said application server, a third referral association between said third user and said first user;
compensating said first user based at least in part on said first referral association and said third referral association; and
compensating said second user based at least in part on said second referral association.

2. The method of claim 1, wherein said first user receives a different amount of compensation for first referral association and said third referral association.

3. The method of claim 1, wherein compensation for said first referral association is based in part on a referral level.

4. The method of claim 1, wherein compensation for said second referral association is based in part on a referral level.

5. The method of claim 1, wherein compensation for said third referral association is based in part on a referral level.

6. The method of claim 1, wherein said data relating to said second user is comprised of an e-mail address.

7. The method of claim 1, wherein said data relating to said third user is comprised of an e-mail address.

8. The method of claim 1, wherein said first referral acceptance from said second user is comprised of identifying information related to said second user.

9. The method of claim 1, wherein said first referral acceptance from said second user is comprised of an acceptance of a referral fee agreement by said second user.

10. The method of claim 1, wherein said second referral acceptance from said third user is comprised of identifying information related to said third user.

11. The method of claim 1, wherein said second referral acceptance from said third user is comprised of an acceptance of a referral fee agreement by said third user.

12. The method of claim 1, wherein said first referral association between said second user and said first user is comprised of a relation to a unique identifier related to said first user.

13. The method of claim 1, wherein said second referral association between said third user and said second user is comprised of a relation to a unique identifier related to said second user.
